(19) United States
(12) Patent Application Publication
(10) Pub. No.: US 2005/0238801 A1
(43) Pub. Date: Oct. 27, 2005

(54) METHOD FOR FABRICATING AN ALIGNMENT LAYER FOR LIQUID CRYSTAL APPLICATIONS

(76) Inventors: Chia-Te Lin, Chia-Yi Hsien (TW); Ta-Shuang Kuan, Hsin-Chu Hsien (TW); Neng-Yu Tseng, Hsin-Chu Hsien (TW); Wen-Fu CHUANG, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,302

(22) Filed: Apr. 27, 2004

(51) Int. Cl. G02F 1/1337

(52) U.S. Cl. 427/162; 427/523

(57) ABSTRACT

A method for forming a non-rubbing alignment layer is provided. A vacuum chamber disposed therein with an evaporation source, a substrate, and an ion source is prepared. The substrate has a flat main surface facing the evaporation source. The ion source generates an ion beam that bombards the flat main surface with an oblique incident angle α with respect to a line normal to the flat main surface. The substrate is rotated at a constant rotation speed. The evaporation source is heated to vaporize inorganic substances of the evaporation source to diffuse and deposit onto the flat main surface substantially along the line normal to the flat main surface, thereby forming the non-rubbing alignment layer. During deposition of the non-rubbing alignment layer, the ion beam emanated from the ion source continues to bombard the flat main surface.

### BACKGROUND OF INVENTION

1. Field of the Invention

The present invention relates generally in the field of liquid crystal displays. More particularly, the present invention relates to an ion-assisted deposition method for fabricating an inorganic alignment layer on a substrate for liquid crystal applications.

2. Description of the Prior Art

Liquid Crystal (LC) displays are widely used in various applications, e.g., video screens, Automatic Teller Machines (ATMs), laptop computers, etc. Generally, the image quality of small-sized LC displays is close to the image quality of conventional CRT displays. However, in some large-sized high-density LC applications, problems including viewing angle, contrast, and display uniformity, response time, etc. are still to be overcome. In the manufacture of LCD devices, as known in the art, the alignment of LC molecules sandwiched between transparent electrodes formed on opposed substrate plates is critical. To obtain better contrast, the orientation of the LC molecules must be uniformly controlled.

The alignment types of the LC molecules are generally divided into three categories: (1) homogeneous alignment, (2) homeotropic or vertical alignment, and (3) tilted homeotropic alignment. The latest is the most applicable one in industry. The LC molecules in contact with the alignment layer are arranged at a pre-tilt angle with respect to the alignment surface. As known in the art, the pre-tilt angle is one of the critical parameters of a LCD device and is determined by physical forces such as hydrogen bond, Van der Waals force, and mechanical forces such as grooves formed on an alignment layer and materials chosen for the alignment layer.

The industry-wide method for producing an alignment layer is through the mechanical rubbing of a polyimide surface. This method requires a physical contact between a rubbing cloth and the polyimide surface. The rubbing process realigns the surface of the polyimide, which then acts as an alignment template for the orientation of the liquid crystal molecules in the preferred pre-tilt direction.

This approach has several disadvantages. For example, because the rubbing method is a contact technique, debris can be generated during the rubbing process resulting in a low process yield. Moreover, additional cleaning steps are generally required to remove the debris. Also, as the roller or brush rubs the surface of the display, electrostatic charges can build up which may discharge through the thin film transistors (TFT) resulting in a lowering of the process yield. Additionally, the rubbing process requires a relatively soft layer in order to modify the surface in a desired orientation. Thus, choice of materials that are suitable for use in the rubbing process is limited.

### SUMMARY OF INVENTION

Accordingly, it is one object of the present invention to provide a non-contact, non-mechanical method to produce an alignment layer for liquid crystal molecules without the need of implementing a conventional rubbing process.

It is another object of the present invention to provide a method for making an inorganic, non-rubbing alignment layer having good alignment characteristics controlled by an ion-assisted deposition (IAD) technique.

According to the claimed invention, a method for forming a non-rubbing alignment layer is provided. A vacuum chamber disposed therein with an evaporation source, a substrate, and an ion source is prepared. The substrate has a flat main surface facing the evaporation source. The ion source generates an ion beam that bombards the flat main surface with an oblique incident angle α with respect to a line normal to the flat main surface. The substrate is rotated at a constant rotation speed. The evaporation source is heated to vaporize inorganic substances of the evaporation source to diffuse and deposit onto the flat main surface substantially along the line normal to the flat main surface, thereby forming the non-rubbing alignment layer. During deposition of the non-rubbing alignment layer, the ion beam emanated from the ion source continues to bombard the flat main surface.

Other objects, advantages, and novel features of the claimed invention will become more clearly and readily apparent from the following detailed description when taken in conjunction with the accompanying drawings.

### BRIEF DESCRIPTION OF DRAWINGS

FIG. 1 is a schematic diagram illustrating a vacuum evaporation system for forming a non-rubbing alignment layer in accordance with one preferred embodiment of this invention.

### DETAILED DESCRIPTION

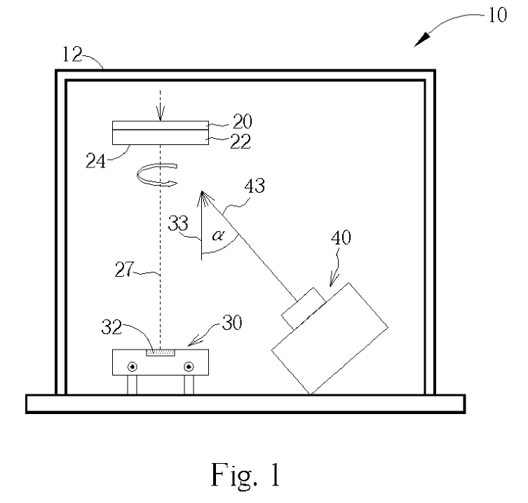

Please refer to FIG. 1. FIG. 1 illustrates a vacuum evaporation system 10 for forming a non-rubbing alignment layer in accordance with one preferred embodiment of this invention. The alignment layer formed according to this invention is applied to liquid crystal panels and is a layer of inorganic materials. The alignment layer is processed and formed in the vacuum evaporation system 10. The vacuum evaporation system 10 comprises a vacuum chamber 12 coupled to a vacuum pumping system (not shown) to control the degree of vacuum in the chamber 12. Within the vacuum chamber 12, an evaporation apparatus 30 is disposed. An evaporation source 32 is provided on the evaporation apparatus 30. An ion gun or an ion beam generator 40 is arranged next to the evaporation apparatus 30 for producing an oblique ion beam 43. The vacuum evaporation system 10 may further comprises a shutter (not shown) and a film thickness monitor (not shown). It is to be understood that the shutter and film thickness monitor for monitoring deposited thickness of the alignment layer on a substrate are both conventional elements in evaporation systems and are thus not further described.

The evaporation apparatus 30 includes a heating mechanism such as an electron beam generator that directs an electron beam onto the evaporation source 32 such that substances of the evaporation source 32 are vaporized and diffuse substantially along an evaporation direction 33 to a flat surface 24 of a substrate 22 that is situated directly above the evaporation source 32 with a distance of about 10 cm˜40 cm. The evaporation direction 33 is substantially parallel with a line 27 normal to the surface 24 of the substrate 22. According to the preferred embodiment, the evaporation source 32 comprises inorganic substances capable of depositing SiOₓ onto the surface 24 of the substrate 22. However, other inorganic materials such as silicon nitride, silicon oxy-nitride may be used.

The substrate 22 is mounted on a rotation seat 20 situated directly above the evaporation apparatus 30. During the evaporation of the evaporation source 32, the substrate 22 rotates at a speed of about 0.008 Hz (0.48 rpm) to 0.2 Hz (12 rpm) along the axis (line) 27. The substrate 22 may be made of glass, ceramic, plastic or silicon, but not limited thereto. It is worthy noted that the evaporation direction 33 is vertical to the flat surface 24 of the substrate 22 that faces the evaporation source 32, such that the substances from evaporation source 32 can uniformly deposit onto the flat surface 24.

The present invention features an ion-assisted deposition of the tilted homeotropic alignment layer. The ion beam generator 40 is place about 20-50 cm from the center of the flat surface 24 of the substrate 22. The ion beam generator 40 generates inert gas ion beam such as argon (Ar) ion beam that emitted from the ion beam generator 40 along the ion beam direction 43. The incident ion beam 43 bombards the flat surface 24 of the substrate 22 at an oblique incident angle α with respect to the normal line 27 of the surface 24, as specifically indicated in FIG. 1. Preferably, the oblique incident angle α is between 30° and 70°, more preferably, between 40° and 45°. The ion energy of the ion beam may be controlled by adjusting the ion current and/or ion voltage. Preferably, the ion current of the ion beam is between 0.1 Amp and 4.5 Amp. The ion voltage is preferably between 10 V and 145 V. By altering the oblique incident angle α, pre-tilt characteristic of the alignment layer is changed. By altering the ion energy of the incident ion beam 43, the alignment force of the alignment layer is optimized.

According to the preferred embodiment, the ion beam bombardment is carried out simultaneously with the evaporation deposition of the alignment layer, i.e., the ion beam bombardment and the evaporation deposition start at the same time. In another case, the ion beam bombardment is executed a short time right after the begin time of the evaporation deposition.

Those skilled in the art will readily observe that numerous modifications and alterations of the present invention method may be made while retaining the teachings of the invention. Accordingly, the above disclosure should be construed as limited only by the metes and bounds of the appended claims.

1. A method for forming a non-rubbing alignment layer, comprising:
providing a vacuum chamber disposed therein with an evaporation source, a substrate, and an ion source, wherein said substrate has a flat main surface facing said evaporation source, and said ion source generates an ion beam that bombards said flat main surface with an oblique incident angle α with respect to a line normal to said flat main surface;
rotating said substrate at a constant rotation speed; and
heating said evaporation source to vaporize inorganic substances of said evaporation source to diffuse and deposit onto said flat main surface substantially along said line normal to said flat main surface, thereby forming said non-rubbing alignment layer, wherein during deposition of said non-rubbing alignment layer, said ion beam emanated from said ion source continues to bombard said flat main surface.

2. The method according to claim 1 wherein said non-rubbing alignment layer is tilted homeotropic alignment layer for liquid crystal molecules.

3. The method according to claim 1 wherein by altering ion energy of said ion beam, alignment force of said non-rubbing alignment layer is optimized.

4. The method according to claim 3 wherein said ion energy of said ion beam is adjusted by changing ion current and/or ion voltage thereof.

5. The method according to claim 4 wherein said ion current is between 0.1 Amp and 4.5 Amp.

6. The method according to claim 4 wherein said ion voltage is between 10 V and 145 V.

7. The method according to claim 1 wherein by altering said oblique incident angle α of said ion beam, pre-tilt of said alignment layer is changed.

8. The method according to claim 7 wherein said oblique incident angle α is between 40° and 45°.

9. The method according to claim 1 wherein said alignment layer is made of SiOₓ.

10. The method according to claim 1 wherein said rotation speed does not exceed 12 rpm.

11. A non-rubbing alignment layer for liquid crystal molecules fabricated according to the method as set forth in claim 1.
